(19) United States
(12) Patent Application Publication
(10) Pub. No.: US 2006/0202141 A1
(43) Pub. Date: Sep. 14, 2006

(54) Valve for a tap

(76) Inventor: Jacob Perlstein, Nidderau (DE)

Correspondence Address: KODA & ANDROLIA, 2029 CENTURY PARK EAST, SUITE 1140, LOS ANGELES, CA, 90067, US

(21) Appl. No.: 10/552,175

(22) PCT Filed: Apr. 8, 2004
(86) PCT No.: PCT/EP04/03763

§ 371 Date: Oct. 5, 2005

(30) Foreign Application Priority Data
Apr. 8, 2003 (DE) 103 15 926.6

(51) Int. Cl. F16K 31/00

(52) U.S. Cl. 251/61.1

(57) ABSTRACT

The invention relates to a valve (6) for a tap. Said valve (6) comprises a main water channel (17, 19), through which the water flows to a tap or similar. The main water channel (17, 19) can be sealed by an elastic membrane (20), the latter (20) always opening when the pressure on its upper side is lower than that on its underside. The pressure on the upper side is generated by a derived circuit (27, 28; 30, 31), which can conduct water from the main water channel (17) onto the upper side of the membrane (20). The membrane (20) is controlled by a pedal. The fact that the derived circuit consists of two zones (27, 28 and 30, 31), one (27, 28) of which is open and the other (30, 31) closed, enables operation at both low and high water pressures. Two permanent magnets (22, 23) are used to transmit the force for opening and closing the two zones of the derived circuit (27, 28; 30, 31), providing a perfect seal for the valve in relation to the environment.

The invention relates to a valve for a water faucet according to the preamble of patent claim 1.

As a rule, water faucets are opened or closed by means of rotating disks or mixing levers, which are located directly on the water faucet or next to the water faucet on a wash basin. Of disadvantage is herein, for example, that the water faucet in the case of a mixing lever is opened with dirty hands or the water faucet cannot be closed while washing one's hands without operating the rotating disk or the mixing lever with wet hands.

To be able to open and close a water faucet without manual operation, electronic controls are known which operate with sensors. These sensors detect the presence of a person at a wash basin or the like and open the water faucet automatically. When the person leaves the wash basin the water faucet is automatically closed. Of disadvantage is here that the user cannot make the decision to open or close a water faucet.

However, foot-operated water faucets are already known which include a special valve (U.S. Pat. No. 5,263,684). This valve comprises a turning mechanism coupled to a water faucet valve in a water line responsive to a foot pedal. An example of a turning mechanism is a cord looped around a drum.

It is furthermore known to operate a diaphragm valve by means of a permanent magnet (DE 39 27 611 A1). Herein a main water channel and a pilot water channel are provided as well as a partially elastic diaphragm, whose underside serves for shutting off and turning on the main water channel. However, the pilot water channel does not represent a bypass to the main water channel and it also does not lead across the top side of the diaphragm.

A regulating device for regulating cold and hot water by means of a water faucet is known, the operation of which taking place with the foot or the like (EP 0 654 628 A1). This device comprises an elastic diaphragm, which can shut off the hot water and cold water inflow. A main and a pilot water channel are also provided. However, the pilot water channel does not represent a bypass to the main water channel.

In another known valve a main water channel with a water inbranch which can be shut off and a water outbranch, one surface of the elastic diaphragm serving for shutting off and turning on the main water channel (WO 96/11350). The valve also comprises a pilot water channel, which leads to another surface of the diaphragm and which is connectable with the water inbranch as well as with the water outbranch of the main water line. A movable closure element can also be moved back and forth between a first and a second portion.

The invention addresses the problem of providing a valve for a water faucet, which can operate without an electric energy supply and without a rotating mechanism.

This problem is resolved according to the characteristics of patent claim 1.

The invention consequently relates to a valve for a water faucet. This valve comprises a main water channel through which the water flows to a water faucet or the like. This main water channel can be shut off by an elastic diaphragm, the diaphragm always opening when the pressure on its top side is lower than on its bottom side. The particular pressure on the top side is generated by a bypass line, which can conduct water from the main water channel onto the top side of the diaphragm. The diaphragm is controlled by a foot pedal. The fact that the bypass line is comprised of two zones with the one zone being open while the other zone is closed, makes operation pososible even at very low as well as also very high water pressure. The use of two permanent magnets for the force transfer to open and close the two zones of the bypass line makes possible the perfect sealing of the valves against the environment.

The advantage attained with the invention comprises in particular that a water faucet can be activated with the foot or other parts of the body. This invention moreover is suitable for retrofitting systems already installed. For example with the available fittings of a wash basin, temperature and quantity of the water can be preset such that the only decision to be made with the foot is water flow ‘Yes’ or ‘No’. In contrast to an electronic fitting, the user himself makes the decision about the opening and closing of the water flow. Application areas of the invention are inter alia public buildings, such as theaters, airports and department stores, semipublic buildings and facilities such as offices, factories and restaurants, houses and rooms in the health field, such as medical offices, hospitals and laboratories, buildings and rooms in the field of food services, such as butcher stores, bakeries or canteen kitchens, kitchens and bathrooms in private residences and areas intended for use by the disabled.

An embodiment example of the invention is depicted in the drawings and will be described in further detail in the following. In the drawings show.

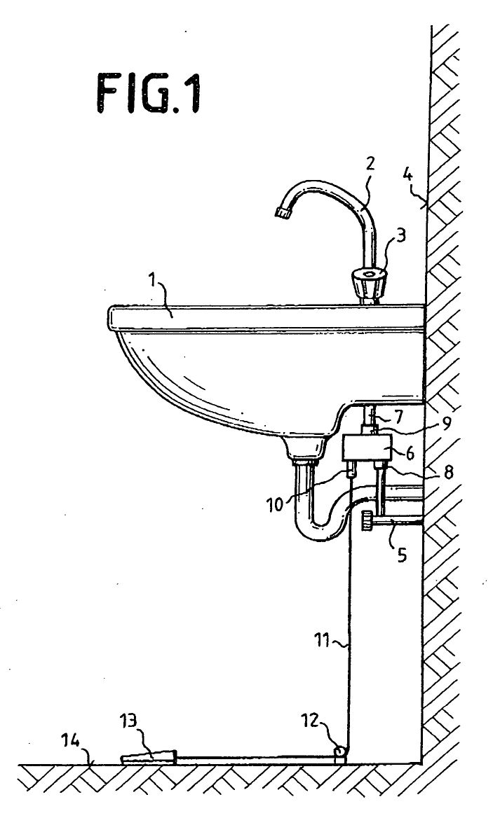

FIG. 1 a valve according to the invention employed in a water inflow for a wash basin,

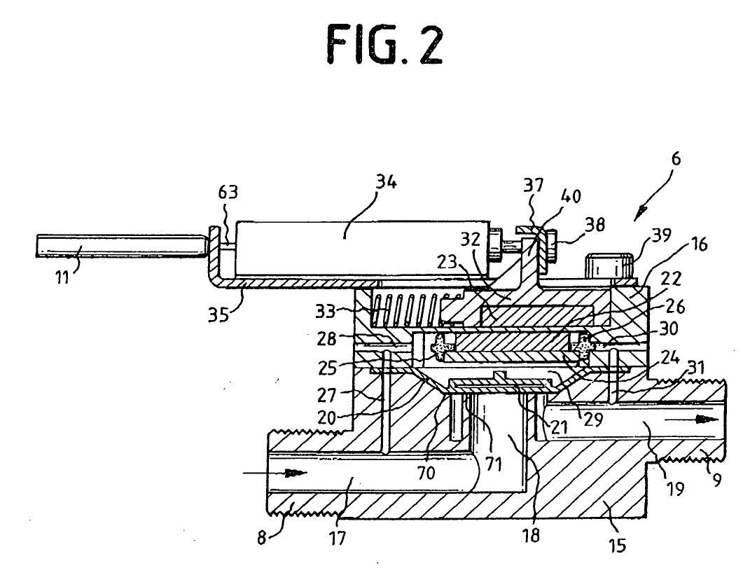

FIG. 2 a partially sectioned view of the valve from the side,

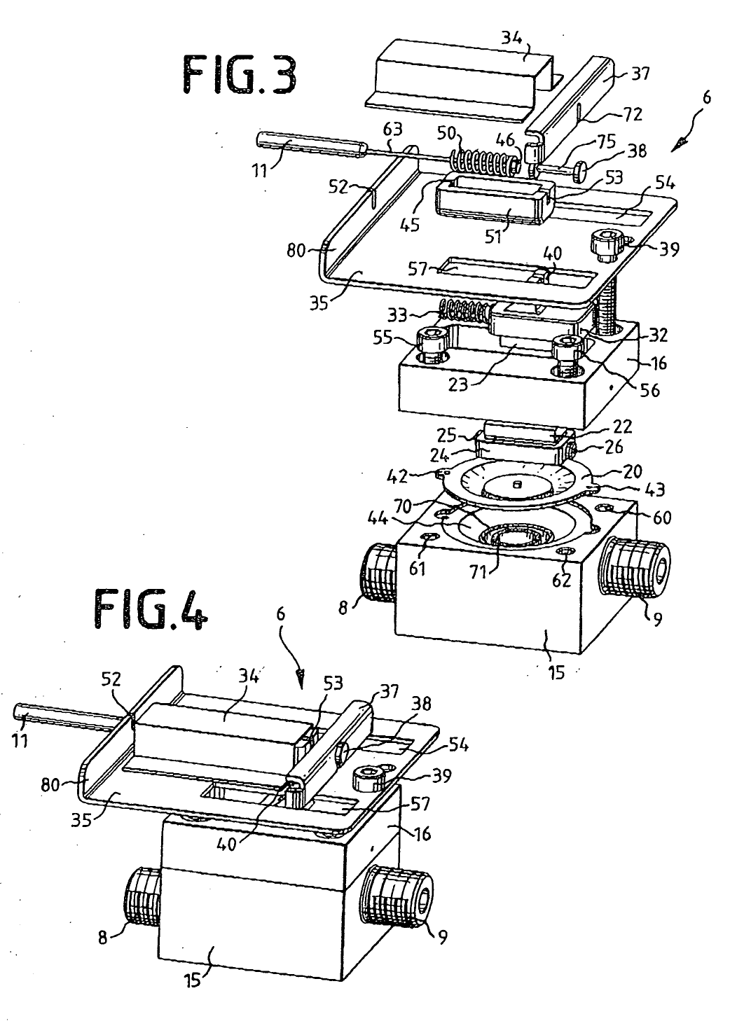

FIG. 3 a perspective exploded view of the valve,

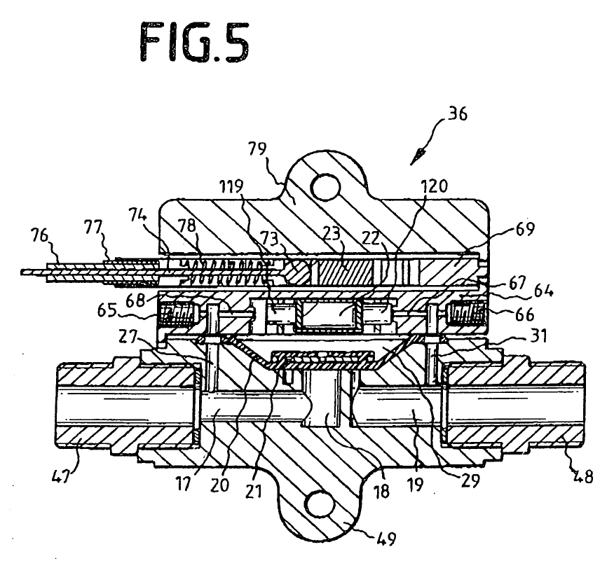

FIG. 4 a perspective representation of the valve in the assembled state,

FIG. 5 a section through a variant of the valve,

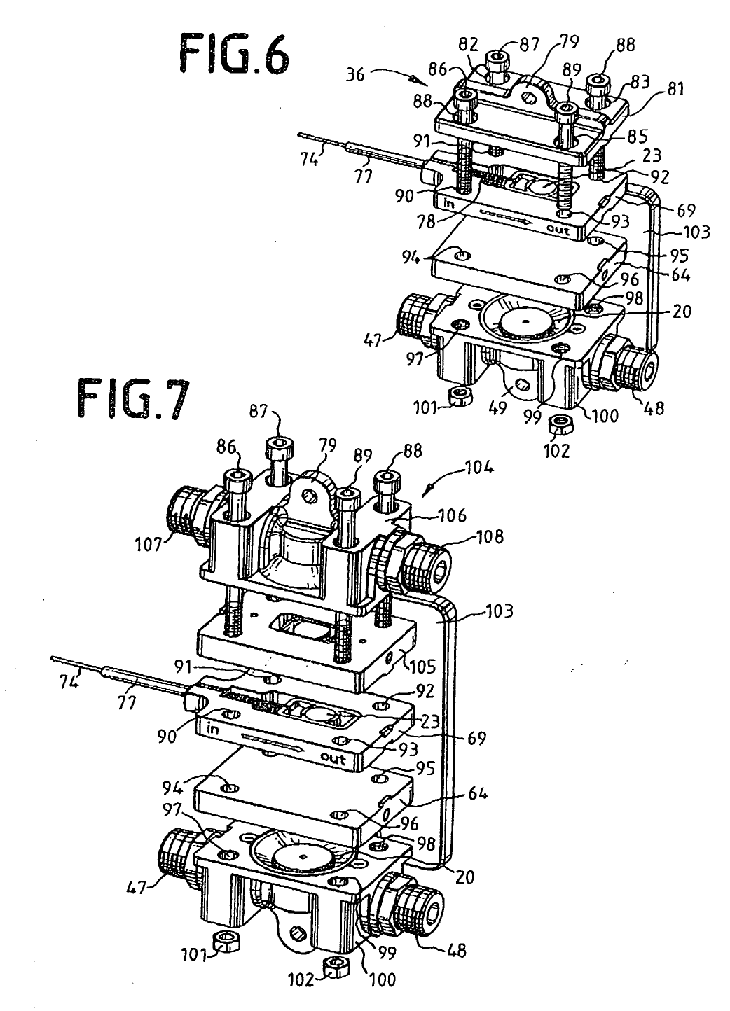

FIG. 6 an exploded representation of the valve variant according to FIG. 5,

FIG. 7 an exploded representation of a variant of the valve for cold and hot water,

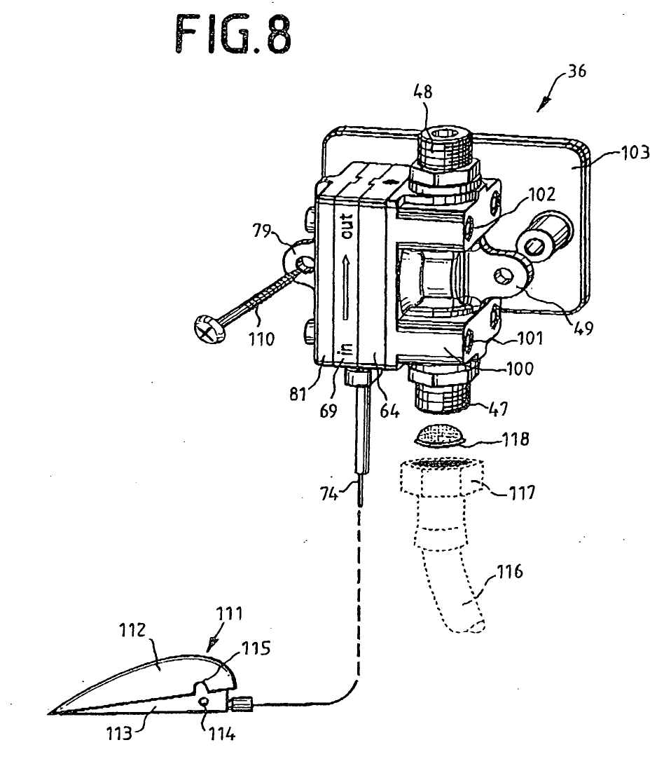

FIG. 8 the valve according to FIG. 6 in the mounted state,

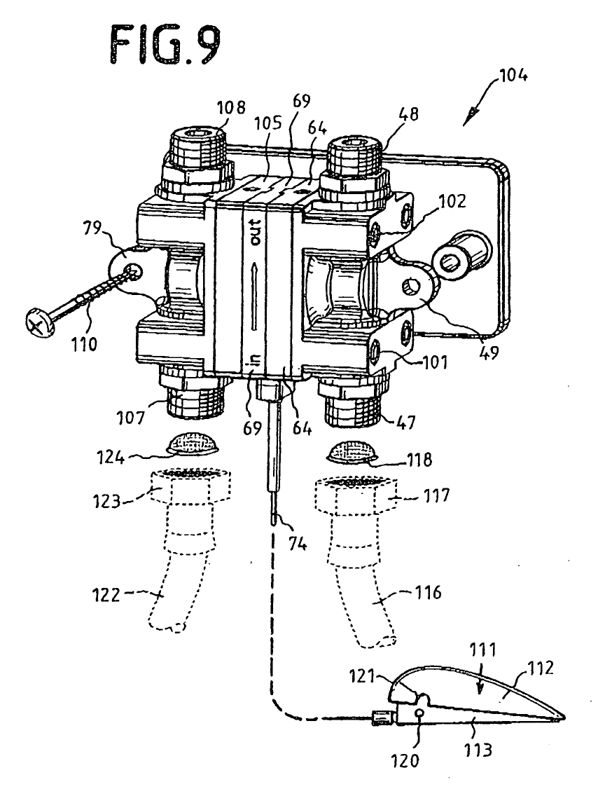

FIG. 9 the valve according to FIG. 7 in the mounted state.

FIG. 1 shows a conventional wash basin 1 in side view, which comprises a water faucet 2 and two operating elements, of which only the operating element 3 is visible. The wash basin 1 is secured on a wall 4, from which projects a water connection 5. This water connection is connected via a valve 6 with a pipe 7 or with a flexible connection line, the pipe 7, in turn, leading to the water faucet 2. It is understood, that the water connection 5, the valve 6 and the pipe 7 can be provided in duplicate, namely one for cold water and one for hot water. Above and beneath the valve 6 are located three pipe fittings 8, 9, 10.

On the connecting sleeve 10 is provided a Bowden cable 11, which corresponds to the Bowden cable of a bicycle brake and which comprises an outer sheathing and an inner synthetic or steel cord. This Bowden cable 11 is guided across a roller 12 and is connected with a foot actuation means or a pedal 13. The pedal 13 can be freely positioned on the floor 14. Since the Bowden cable 11 is a cable such as is used in bicycle handbrakes, a deflection roller 12 is actually not necessary, e.g. the Bowden cable 11 can be freely placed between the pedal 13 and the valve 6.

Through the operating element 3, visible in FIG. 1, and an operating element located behind it and not visible, water throughflow and temperature are preset. Instead of two operating elements 3 a single-lever mixer can also be provided.

By actuating the pedal 13 by foot, hot and cold water can be made to flow as long as the pedal is depressed. By taking the foot off the pedal 13 the water flow is stopped. When the pedal 13 is pressed all the way down, the pedal remains fixed in this position and water flows continuously through the valve 6. By actuating the pedal 13 again, the latter is released and returns into its original position. The water flow through the valve 6 is stopped. The pedal 13 can be implemented with or without latch-on function. With latch-on function it is preferably employed in private homes, in the area of food services, in medical offices and in laboratories, while without latch-on function it is preferably employed in the public area and in hospitals.

FIG. 2 depicts the partially sectioned valve 6 in side view. This valve 6 comprises a main body 15 and a superstructure 16. The pipe fittings 8, 9 form a portion of a main water channel 17, 18, 19. This main water channel 17 to 19 can be interrupted by an elastic diaphragm 20, which has in its central region a reinforcement 21, for example of metal. Above the diaphragm 20 is located a first permanent magnet 22, above which is disposed a second permanent magnet 23. The first permanent magnet 22 is disposed in a magnet bed 24. A rubber seal 25, 26 is provided on both sides of the first permanent magnet 22. These rubber seals 25, 26 serve for opening and closing pilot water channels. One pilot water channel 27 branches off from main water channel 17 and leads via a line 28 to a space 29 above diaphragm 20. This space 29 is connectable to a line 30, which is connected with a further pilot water channel 31. Together the pilot water channels 27, 28, 30, 31 form a bypass or shunt, which is led across the surface of diaphragm 20. The connecting sleeve 10 encompassing the end of the Bowden cable 11 is omitted in FIG. 2. It is understood that the lines 28, 30 are tightly closed on their left or right side, respectively.

Above the second magnet 23 is a magnet roof 32, on which adjoins a soft main coil spring 33. Above this main coil spring 33 is provided a cover 34, which rests on a bracket 35. Bracket 35 serves as a guide for the cable 63 of the Bowden cable 11. The bracket 35 serves thus as a resistance against the sleeve of the Bowden cable 11. To the right of the cover 34 is provided a bridge 37, through which is placed a connecting pin 38. A clamp bolt 39 is located to the right of the connecting pin 38.

The bracket 35 in FIG. 2 can operate two valves—one valve each for cold or hot water—connected to one another. In this case the two valves are secured on the wall. However, only one Bowden cable 11 and only one pedal 13 are being utilized, and the two valves are actuated simultaneously via the bridge 37. A different bracket is provided for a single valve. A single valve can be mounted directly on the angle-type valve 5 or on the wall.

The operating function of valve 6 in the condition depicted in FIG. 2 is the following:

The right rubber seal 26 closes line 30, since the main coil spring 33 presses the upper magnet 23 to the right. This magnet 23 entrains the magnet 22 to the right, since both magnets 22, 23 have opposite polarity and consequently attract each other strongly.

Via the pipe fitting 8 water reaches the main water channel 17, 18 up to the lower side of diaphragm 20. The water flows parallel to the top side of diaphragm 20 across the pilot water channel 27 and the line 28. The water pressure acting on both sides of the diaphragm 20, is equal. Since the water in space 29 acts onto a larger diaphragm area than the water of main water channel 18, the force acting from above is greater than that acting from below, i.e. the diaphragm 20 remains closed, and therewith the entire valve 6 is closed.

When the pedal 13 is depressed, the Bowden cable 63 moves to the left and a spring reception 51, not shown in FIG. 3 and not visible in FIG. 2, which is located in the cover 34, also moves to the left. Via the pin 38 and the bridge 37 the upper magnet 23 is pulled to the left against the force of the main spring 33. The bridge 37 extends behind a fork 40, which is a portion of the magnet roof 32 for magnet 23. Since this magnet 23 is magnetically coupled with the lower magnet 22, the lower magnet 22, and with it the rubber sealings 25, 26, is also moved to the left. Hereby line 28 is closed by seal 25, while line 30 is opened. The water pressure above the diaphragm 20 is now relieved, since the pilot channel 31 is open and the water above the diaphragm 20 flows into the main water channel 19. The water pressure beneath the diaphragm 20 is now greater than above the diaphragm 20. Since the diaphragm 20 is elastic, it is deflected upward and allows the water of the main water channel 18 to flow to the main water channel 19. Therewith the valve 6 is opened.

When the pedal 13 is released, the main spring 33 presses the upper magnet 23 to the right, and therewith also the rubber seal 26 in the same direction, closing line 30. The rubber seal 25 simultaneously opens line 28 such that the initial state is restored again.

FIG. 3 shows a perspective exploded representation of valve 6. Evident herein is again the main spring 33 connected with the magnet roof 32, on which the upper magnet 23 is fastened. In addition to clamp bolt 39, two further clamp bolts 55, 56 are evident, which fit into bores 60, 61, 62 of the main body 15. The lower magnet 22 with the magnet bed 24 and the two seals 25, 26 is located above the diaphragm 20, which is provided with two margin ears 42, 43. Beneath the diaphragm 20 is evident a diaphragm seat 44 comprising two circular seats 70, 71 for the diaphragm 20. On the magnet roof 32 is located a fork 40, which, when the pedal 13 is actuated, is entrained by the front end of bridge 37. In this case bridge 37 is moved to the left, since it is connected with a secondary spring bed 51 via a connection pin 38. The shaft 75 of this pin 38 is here placed through a slot 53 of the secondary spring bed 51. The slot 54 is provided for a second valve, which is not shown.

The spring 50 is a hard secondary spring. This spring 50 ensures that when the Bowden cable 63 is pulled, the main spring 33 has in fact reached its end position. It additionally absorbs possible excessive force if it is compressed.

The spring 50, which is harder than the main spring 33, is wound about the end of the Bowden cable 63 closed off by a head 46. The Bowden cable 63 is guided through a slot 45 in the secondary spring bed 51. When the Bowden cable 63 is pulled, first the movable secondary spring bed 51 is moved to the left up to the boundary limit 80 of bracket 35. Through this movement the magnet roof 32 also moves against the main spring 33 to the left, since this magnet roof 32 is coupled via bridge 37 with the secondary spring bed 51. In this process the secondary spring 50 is initially not markedly compressed, since it is harder than spring 33. If, however, the Bowden cable 63 is pulled further with greater forces, the secondary spring 50 is also compressed. However, valve 6 is already being opened when only the main spring 33 is compressed.

If the secondary spring 50 were to be omitted, a user could not be certain whether or not the valve is in fact fully opened when the pedal is fully pressed all the way, for the Bowden cable 63 could have become stretched. However, since the user has perceived a first response when the pedal has been depressed and, upon further depressing it, a second response, he knows that the valve is fully opened, because the second response ensures that the spring 33 is fully compressed.

Four phases of pedal 13 correspond to the above described spring movements. The first phase defines the starting state, i.e. the valve 6 is closed. In the second phase the pedal 13 is slightly depressed, such that only the soft main spring 33 is compressed. In the third phase the pedal is pressed more strongly such that the secondary spring 50 is also compressed. In the fourth phase the pedal 13 remains fixed in its lower position. With additional pressure on the pedal, it returns back into the starting state. It is consequently possible to go back with the valve to manual operation or to the previous state of the water faucet.

FIG. 4 shows again the valve 6 of FIG. 3 in the assembled state. Evident herein is the main body 15 with its two pipe fittings 8 and 9. Above this main body 15 is disposed the superstructure 16, on which is located bracket 35 with the boundary limit 80 with slot 52. Bracket 35 is bolt-connected with the main body 15 by means of bolt 39. The connecting pin 38 establishes the connection between bridge 37 and bed 51 of the secondary spring 50, such that the bridge 37 can be moved horizontally when the bed 51 is moved horizontally. Bed 51 is in contact on bracket 35 and is only guided through cover 34.

In FIG. 5 a section through a variant of valve 6 is depicted. The reference numbers of this valve 36 correspond to the reference numbers of valve 6 to the extent the structural parts have the same function in both cases. The pilot water channels 27, 31 are led through an opening in the seat of the diaphragm 20.

In the variant of FIG. 5 the main water channel portions 17 and 19 are in the same plane and are continued through bolted in hollow bolts 47, 48. Between these hollow bolts 47, 48 is located a bracket 49 with a throughbore 58. Above the inner permanent magnet 22 is disposed the outer permanent magnet 23. The inner permanent magnet 22 is located in a synthetic case and, together with it, is embedded in a body 64. Slugs closing off the channels 67, 68 corresponding to channels 28, 30 in FIG. 2 are denoted by 65, 66. The closure elements 119, 120 correspond functionally to the closure elements 25, 26 in FIG. 2.

Outer magnet 23 is also located in a synthetic case and is set with it into a body 69.

On one side of the synthetic case of this outer magnet 23 abuts a ball 73, which forms the end of a Bowden cable 74, which is encompassed by sheathings 76, 77 abutting the body 69. When the ball 73 is pulled against the force of a spring 78, the permanent magnet 23 migrates to the left and entrains the permanent magnet 22, which thereupon closes the pilot water channel 27 and opens the pilot water channel 31. The ball 73 is connected with the synthetic case encompassing the permanent magnet 22.

Above body 69 is located a bracket 79, which is disposed mirror-symmetrically to bracket 49. It is understood that instead of two magnets 22, 23, also only one magnet can be provided, a ferromagnetic structural part taking the place of the other magnet.

FIG. 6 shows the valve 36 again in an exploded view. Bracket 79 is a portion of a body 81, which is provided with four bores 82 to 85. Through each of these bores 82 to 85 is placed a hexagonal socket screw 86 to 89 and guided through bores 90 to 93 in body 69 as well as through bores 94 to 96 in body 64 as well as through bores 97 to 99 in body 100. Subsequently nuts 101, 102 are mounted onto the ends of the hexagonal socket screws 86 to 89. By 103 is denoted an end sheet.

While the above described Figures show only one valve for one water conduit, FIG. 7 shows one valve 104 for two water conduits, thus for one cold and one hot water line.

Bodies 69, 64 and 100 of FIG. 7 correspond to bodies 69, 64 and 100 of FIG. 6. One body 105, which functionally corresponds to body 69, is additionally provided. One body 106 above the body 105 is structured like body 100, i.e. it includes a diaphragm not visible in FIG. 7 and comprises main water channel parts 107, 108.

With the arrangement according to FIG. 7 two main water channels can be controlled using only one Bowden cable 74 and one permanent magnet 23.

FIG. 8 shows the valve 36 in the mounted state. It can be seen that the valve 36 can be bolted together with a support 103 by means of bolts, of which only one bolt 110 is shown. The Bowden cable 74 leads to a foot control 111 comprised of a movable upper part 112 and a fixed lower part 113. By 114 is denoted a pin on the lower part 113, which can engage a recess 115 in the upper part.

In addition, a connecting tube 116 is evident, which can be bolted with the pipe fitting 47, and between the end piece 117 of tube 116 and pipe fitting 47 a screen 118 can be provided.

FIG. 9 depicts the valve 104 according to FIG. 7 in the mounted state. Two tubes 116, 122 with two end pieces 117, 123 are shown, which can be screw-connected with the pipe fittings 47, 107. The screens 118, 124 can be placed into the pipe fittings 47, 107 before the end pieces 117, 124 are screwed onto the pipe fittings 47, 107.

With the single Bowden cable 74 cold water channels 47, 48 as well as also hot water channels 107, 108 can be opened or closed.

In comparison to valve 6 according to FIG. 2, valve 36 according to FIG. 5 is structured more compactly and requires only one spring.

1. Valve for a water faucet, with
1.1 a main water channel (18), which can be shut off, comprising a water inflow (17) and a water outflow (19),
1.2 an at least partially elastic diaphragm (20) whose surface serves for shutting off and turning on the main water channel (18),
1.3 a pilot water channel (27, 28, 30, 31), which leads to the other surface of the diaphragm (20) and which is connectable with the water inbranch (17) as well as also with the water outbranch (19) of the main water channel (10), and
1.4 a movable closure element (22, 24, 25, 26) which can be moved back and forth between a first and a second position,
characterized in
that the movable closure element (22, 24, 25, 26) can be moved linearly by means of magnetostatic forces and the movable closure element (22, 24, 25, 26) has two closure parts (25, 26; 119, 120), of which the first closure part (25; 119) in a first position of the closure element (22, 24, 25, 26) closes the pilot channel (27, 28) on the side of the water inbranch, while the second closure part (26; 120) opens the pilot channel (30, 31) on the side of the water outbranch, and
that in a second position of the closure element (22, 24, 25, 26) the first closure part (25) opens the pilot channel (27, 28) on the side of the water inbranch, while the second closure part (26) closes the pilot channel (30, 31) on the side of the water outbranch.

2. Valve as claimed in claim 1, characterized in that the closure elements (25, 26; 119, 120) are disposed on opposite ends of a movable arrangement (22, 24).

3. Valve as claimed in claim 2, characterized in that the movable arrangement (22, 24) comprises a permanent magnet (22).

4. Valve as claimed in claim 1, characterized in that a spring (33) is compressible by means of a foot-operated Bowden cable (11) and a support part (32), this support part supporting a permanent magnet (23).

5. Valve as claimed in claims 3 and 4, characterized in that the permanent magnets (22, 23) are spaced apart from one another and are magnetically coupled.

6. Valve as claimed in claim 1, characterized in that the main water channel is comprised of a first region which includes a portion (17) extending in a first direction and a second portion (18) extending perpendicularly to it, as well as a second region comprising a portion (19) which extends in the same direction as the first portion (17).

7. Valve as claimed in claims 1 and 6, characterized in that when the valve (6) is closed the elastic diaphragm (20) rests with its underside on the second portion (18) of the first region.

8. Valve as claimed in claim 7, characterized in that the water discharge area of the second portion is smaller than the area of the upper side of the elastic diaphragm (20).

9. Valve as claimed in claim 4, characterized in that the support part (32) which can compress the first spring (33) is movable by means of an arrangement (35) which has a reception (51) for a second spring (50).

10. Valve as claimed in claim 9, characterized in that the first spring (33) is softer than the second spring (50).

11. Valve as claimed in claim 9, characterized in that the reception for the second spring (50) is provided with at least one slot in one wall, with a cable (63) being guided through the slot, about which the spring (50) is wound.

12. Valve as claimed in claim 1, characterized in that the water inbranch (17) and the water outbranch (19) are provided in a common plane.

13. Valve as claimed in claim 1, characterized in that the magnetostatic forces are generated by a magnet (23) which is linearly movable by means of a control device (111).

14. Valve as claimed in claim 13, characterized in that in the plane of the linearly movable magnet (23) a coil spring (78) is provided, through the interior of which extends a wire (74).

15. Valve as claimed in claim 14, characterized in that the end of the wire (74) is directly or indirectly connected with the magnet (23).
